(19) United States
(12) Patent Application Publication
(10) Pub. No.: US 2017/0187635 A1
(43) Pub. Date: Jun. 29, 2017

(54) SYSTEM AND METHOD OF JITTER BUFFER MANAGEMENT

(71) Applicant: QUALCOMM Incorporated, San Diego, CA (US)

(72) Inventors: Subasingha Shaminda Subasingha, Weston, FL (US); Vivek Rajendran, San Diego, CA (US); Duminda Dewasurendra, San Diego, CA (US); Venkatraman Atti, San Diego, CA (US); Venkata Subrahmanyam Chandra Sekhar Chebiyyam, San Diego, CA (US)

(21) Appl. No.: 15/372,780

(22) Filed: Dec. 8, 2016

Related U.S. Application Data
(60) Provisional application No. 62/271,994, filed on Dec. 28, 2015.

(51) Int. Cl. H04L 12/841; H04L 12/26; H04W 28/02; H04L 12/823

(52) U.S. Cl. CPC H04L 47/283; H04L 47/32; H04L 43/0829; H04L 43/16; H04W 28/0236

(57) ABSTRACT

A method for adjusting a delay of a buffer at a receiving terminal includes determining, at a processor, a partial frame recovery rate of lost frames at the receiving terminal. The method also includes adjusting the delay of the buffer based at least in part on the partial frame recovery rate.

### I. CROSS REFERENCE TO RELATED APPLICATIONS

The present application claims the benefit of U.S. Provisional Patent Application No. 62/271,994, entitled “SYSTEM AND METHOD OF JITTER BUFFER MANAGEMENT,” filed Dec. 28, 2015, which is expressly incorporated by reference herein in its entirety.

### II. FIELD

The present disclosure is generally related to jitter buffer management.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, may communicate voice and data packets over wireless networks. Further, many such wireless telephones include other types of devices that are incorporated therein. For example, a wireless telephone may also include a digital still camera, a digital video camera, a digital recorder, and an audio file player. Also, such wireless telephones may process executable instructions, including software applications, such as a web browser application, that may be used to access the Internet. As such, these wireless telephones may include significant computing capabilities.

Transmission of voice by digital techniques is widespread, particularly in long distance and digital radio telephone applications. To conserve resources, there is interest in sending as little information over a channel as possible during a digital voice call, while maintaining a perceived quality of reconstructed speech. If speech is transmitted by sampling and digitizing, a data rate on the order of sixty-four kilobits per second (kbps) may be used to achieve a speech quality of an analog telephone. Through the use of speech analysis, followed by coding, transmission, and re-synthesis at a receiver, a significant reduction in the data rate may be achieved.

Devices for compressing speech may find use in many fields of telecommunications. An exemplary field is wireless communications. The field of wireless communications has many applications including, e.g., cordless telephones, paging, wireless local loops, wireless telephony such as cellular and personal communication service (PCS) telephone systems, mobile Internet Protocol (IP) telephony, and satellite communication systems. A particular application is wireless telephony for mobile subscribers.

Various over-the-air interfaces have been developed for wireless communication systems including, e.g., frequency division multiple access (FDMA), time division multiple access (TDMA), code division multiple access (CDMA), and time division-synchronous CDMA (TD-SCDMA). In connection therewith, various domestic and international standards have been established including, e.g., Advanced Mobile Phone Service (AMPS), Global System for Mobile Communications (GSM), and Interim Standard 95 (IS-95). An exemplary wireless telephony communication system is a code division multiple access (CDMA) system. The IS-95 standard and its derivatives, IS-95A, ANSI J-STD-008, and IS-95B (referred to collectively herein as IS-95), are promulgated by the Telecommunication Industry Association (TIA) and other well-known standards bodies to specify the use of a CDMA over-the-air interface for cellular or PCS telephony communication systems.

The IS-95 standard subsequently evolved into “3G” systems, such as cdma2000 and WCDMA, which provide more capacity and high speed packet data services. Two variations of cdma2000 are presented by the documents IS-2000 (cdma2000 1xRTT) and IS-856 (cdma2000 1xEV-DO), which are issued by TIA. The cdma2000 1xRTT communication system offers a peak data rate of 153 kbps whereas the cdma2000 1xEV-DO communication system defines a set of data rates, ranging from 38.4 kbps to 2.4 Mbps. The WCDMA standard is embodied in 3rd Generation Partnership Project “3GPP”, Document Nos. 3G TS 25.211, 3G TS 25.212, 3G TS 25.213, and 3G TS 25.214. The International Mobile Telecommunications Advanced (IMT-Advanced) specification sets out “4G” standards. The IMT-Advanced specification sets peak data rate for 4G service at 100 megabits per second (Mbit/s) for high mobility communication (e.g., from trains and cars) and 1 gigabit per second (Gbit/s) for low mobility communication (e.g., from pedestrians and stationary users).

Devices that employ techniques to compress speech by extracting parameters that relate to a model of human speech generation are called speech coders. Speech coders may comprise an encoder and a decoder. The encoder divides the incoming speech signal into blocks of time or analysis frames. The duration of each segment in time (or “frame”) may be selected to be short enough that the spectral envelope of the signal may be expected to remain relatively stationary. For example, one frame length is twenty milliseconds, which corresponds to 160 samples at a sampling rate of eight kilohertz (kHz), although any frame length or sampling rate deemed suitable for the particular application may be used.

The encoder analyzes the incoming speech frame to extract certain relevant parameters, and then quantizes the parameters into binary representation, e.g., to a set of bits or a binary data packet. The data packets are transmitted over a communication channel (i.e., a wired and/or wireless network connection) to a receiver and a decoder. The decoder processes the data packets, unquantizes the processed data packets to produce the parameters, and resynthesizes the speech frames using the unquantized parameters.

The function of the speech coder is to compress the digitized speech signal into a low-bit-rate signal by removing natural redundancies inherent in speech. The digital compression may be achieved by representing an input speech frame with a set of parameters and employing quantization to represent the parameters with a set of bits. If the input speech frame has a number of bits Nᵢ and a data packet produced by the speech coder has a number of bits Nₒ, the compression factor achieved by the speech coder is Cᵣ=Nᵢ/Nₒ. The challenge is to retain high voice quality of the decoded speech while achieving the target compression factor. The performance of a speech coder depends on (1) how well the speech model, or the combination of the analysis and synthesis process described above, performs, and (2) how well the parameter quantization process is performed at the target bit rate of Nₒ bits per frame. The goal of the speech model is thus to capture the essence of the speech signal, or the target voice quality, with a small set of parameters for each frame.

Speech coders generally utilize a set of parameters (including vectors) to describe the speech signal. A good set of parameters provides a low system bandwidth for the reconstruction of a perceptually accurate speech signal. Pitch, signal power, spectral envelope (or formants), amplitude and phase spectra are examples of the speech coding parameters.

Speech coders may be implemented as time-domain coders, which attempt to capture the time-domain speech waveform by employing high time-resolution processing to encode small segments of speech (e.g., 5 millisecond (ms) sub-frames) at a time. For each sub-frame, a high-precision representative from a codebook space is found by means of a search algorithm. Alternatively, speech coders may be implemented as frequency-domain coders, which attempt to capture the short-term speech spectrum of the input speech frame with a set of parameters (analysis) and employ a corresponding synthesis process to recreate the speech waveform from the spectral parameters. The parameter quantizer preserves the parameters by representing them with stored representations of code vectors in accordance with known quantization techniques.

One time-domain speech coder is the Code Excited Linear Predictive (CELP) coder. In a CELP coder, the short-term correlations, or redundancies, in the speech signal are removed by a linear prediction (LP) analysis, which finds the coefficients of a short-term formant filter. Applying the short-term prediction filter to the incoming speech frame generates an LP residue signal, which is further modeled and quantized with long-term prediction filter parameters and a subsequent stochastic codebook. Thus, CELP coding divides the task of encoding the time-domain speech waveform into the separate tasks of encoding the LP short-term filter coefficients and encoding the LP residue. Time-domain coding can be performed at a fixed rate (i.e., using the same number of bits, No, for each frame) or at a variable rate (in which different bit rates are used for different types of frame contents). Variable-rate coders attempt to use the amount of bits needed to encode the codec parameters to a level adequate to obtain a target quality.

Time-domain coders such as the CELP coder may rely upon a high number of bits, No, per frame to preserve the accuracy of the time-domain speech waveform. Such coders may deliver excellent voice quality provided that the number of bits, No, per frame is relatively large (e.g., 8 kbps or above). At low bit rates (e.g., 4 kbps and below), time-domain coders may fail to retain high quality and robust performance due to the limited number of available bits. At low bit rates, the limited codebook space clips the waveform-matching capability of time-domain coders, which are deployed in higher-rate commercial applications. Hence, despite improvements over time, many CELP coding systems operating at low bit rates suffer from perceptually significant distortion characterized as noise.

An alternative to CELP coders at low bit rates is the “Noise Excited Linear Predictive” (NELP) coder, which operates under similar principles as a CELP coder. NELP coders use a filtered pseudo-random noise signal to model speech, rather than a codebook. Since NELP uses a simpler model for coded speech, NELP achieves a lower bit rate than CELP. NELP may be used for compressing or representing unvoiced speech or silence.

Coding systems that operate at rates on the order of 2.4 kbps are generally parametric in nature. That is, such coding systems operate by transmitting parameters describing the pitch-period and the spectral envelope (or formants) of the speech signal at regular intervals. Illustrative of these so-called parametric coders is the LP vocoder system.

LP vocoders model a voiced speech signal with a single pulse per pitch period. This basic technique may be augmented to include transmission information about the spectral envelope, among other things. Although LP vocoders provide reasonable performance generally, they may introduce perceptually significant distortion, characterized as buzz.

In recent years, coders have emerged that are hybrids of both waveform coders and parametric coders. Illustrative of these so-called hybrid coders is the prototype-waveform interpolation (PWI) speech coding system. The PWI coding system may also be known as a prototype pitch period (PPP) speech coder. A PWI coding system provides an efficient method for coding voiced speech. The basic concept of PWI is to extract a representative pitch cycle (the prototype waveform) at fixed intervals, to transmit its description, and to reconstruct the speech signal by interpolating between the prototype waveforms. The PWI method may operate either on the LP residual signal or the speech signal.

Electronic devices, such as wireless telephones, may send and receive data via networks. For example, audio data may be sent and received via a circuit-switched network (e.g., the public switched telephone network (PSTN), a global system for mobile communications (GSM) network, etc.) or a packet-switched network (e.g., a voice over internet protocol (VoIP) network, a voice over long term evolution (VoLTE) network, etc.). In a packet-switched network, audio packets may be individually routed from a source device to a destination device. Due to network conditions, the audio packets may arrive out of order. The destination device may store received packets in a jitter buffer and may rearrange the received packets if the received packets are out-of-order.

The destination device may reconstruct data based on the received packets. A particular packet sent by the source device may not be received, or may be received with errors, by a destination device. The destination device may be unable to recover all or a portion of the data associated with the particular packet. The destination device may reconstruct the data based on incomplete packets. The data reconstructed based on incomplete packets may have degraded quality that adversely impacts a user experience. Alternatively, the destination device may request the source device to retransmit the particular packet and may delay reconstructing the data while waiting to receive a retransmitted packet. The delay associated with requesting retransmission and reconstructing the data based on a retransmitted packet may be perceptible to a user and may result in a negative user experience.

### IV. SUMMARY

According to one implementation of the present disclosure, a method for adjusting a delay (e.g., a playout delay) of a buffer at a receiving terminal includes determining, at a processor, a partial frame recovery rate of lost frames at the receiving terminal. The method also includes adjusting the delay of the buffer based at least in part on the partial frame recovery rate.

According to another implementation of the present disclosure, an apparatus for adjusting a delay of a buffer at a receiving terminal includes a processor and a memory storing instructions that are executable by the processor to perform operations. The operations include determining a partial frame recovery rate of lost frames at the receiving terminal and adjusting the delay of the buffer based at least in part on the partial frame recovery rate.

According to another implementation of the present disclosure, a non-transitory computer-readable medium includes instructions for adjusting a delay of a buffer at a receiving terminal. The instructions, when executed by a processor, cause the processor to perform operations including determining a partial frame recovery rate of lost frames at the receiving terminal and adjusting the delay of the buffer based at least in part on the partial frame recovery rate.

According to another implementation of the present disclosure, an apparatus for adjusting a delay of a buffer at a receiving terminal includes means for determining a partial frame recovery rate of lost frames at the receiving terminal. The apparatus also includes means for adjusting the delay of the buffer based at least in part on the partial frame recovery rate.

### V. BRIEF DESCRIPTION OF THE DRAWINGS

FIG. 1 is a block diagram of a particular illustrative implementation of a system that is operable to adjust a delay of a buffer at a receiving terminal;

FIG. 2 is a diagram of a particular implementation of method of adjusting a delay of a buffer at a receiving terminal;

FIG. 3 is a diagram of another particular implementation of method of adjusting a delay of a buffer at a receiving terminal;

FIG. 4 is a block diagram of a particular illustrative implementation of a device that is operable to adjust a delay of a buffer at a receiving terminal; and

FIG. 5 is a block diagram of a base station that is operable to adjust a delay of a buffer.

### VI. DETAILED DESCRIPTION

The principles described herein may be applied, for example, to a headset, a handset, other audio device, or a component of a device that is configured to use jitter buffer. Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from another component, block or device), and/or retrieving (e.g., from a memory register or an array of storage elements).

Unless expressly limited by its context, the term “producing” is used to indicate any of its ordinary meanings, such as calculating, generating, and/or providing. Unless expressly limited by its context, the term “providing” is used to indicate any of its ordinary meanings, such as calculating, generating, and/or producing. Unless expressly limited by its context, the term “coupled” is used to indicate a direct or indirect electrical or physical connection. If the connection is indirect, it is well understood by a person having ordinary skill in the art, that there may be other blocks or components between the structures being “coupled”.

The term “configuration” may be used in reference to a method, apparatus/device, and/or system as indicated by its particular context. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). In the case (i) where A is based on B includes based on at least, this may include the configuration where A is coupled to B. Similarly, the term “in response to” is used to indicate any of its ordinary meanings, including “in response to at least.” The term “at least one” is used to indicate any of its ordinary meanings, including “one or more”. The term “at least two” is used to indicate any of its ordinary meanings, including “two or more”.

The terms “apparatus” and “device” are used generically and interchangeably unless otherwise indicated by the particular context. Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The terms “method,” “process,” “procedure,” and “technique” are used generically and interchangeably unless otherwise indicated by the particular context. The terms “element” and “module” may be used to indicate a portion of a greater configuration. The term “packet” may correspond to one or more frames. Any incorporation by reference of a portion of a document shall also be understood to incorporate definitions of terms or variables that are referenced within the portion, where such definitions appear elsewhere in the document, as well as any figures referenced in the incorporated portion.

As used herein, the term “communication device” refers to an electronic device that may be used for voice and/or data communication over a wireless communication network. Examples of communication devices include cellular phones, personal digital assistants (PDAs), handheld devices, headsets, wireless modems, laptop computers, personal computers, etc.

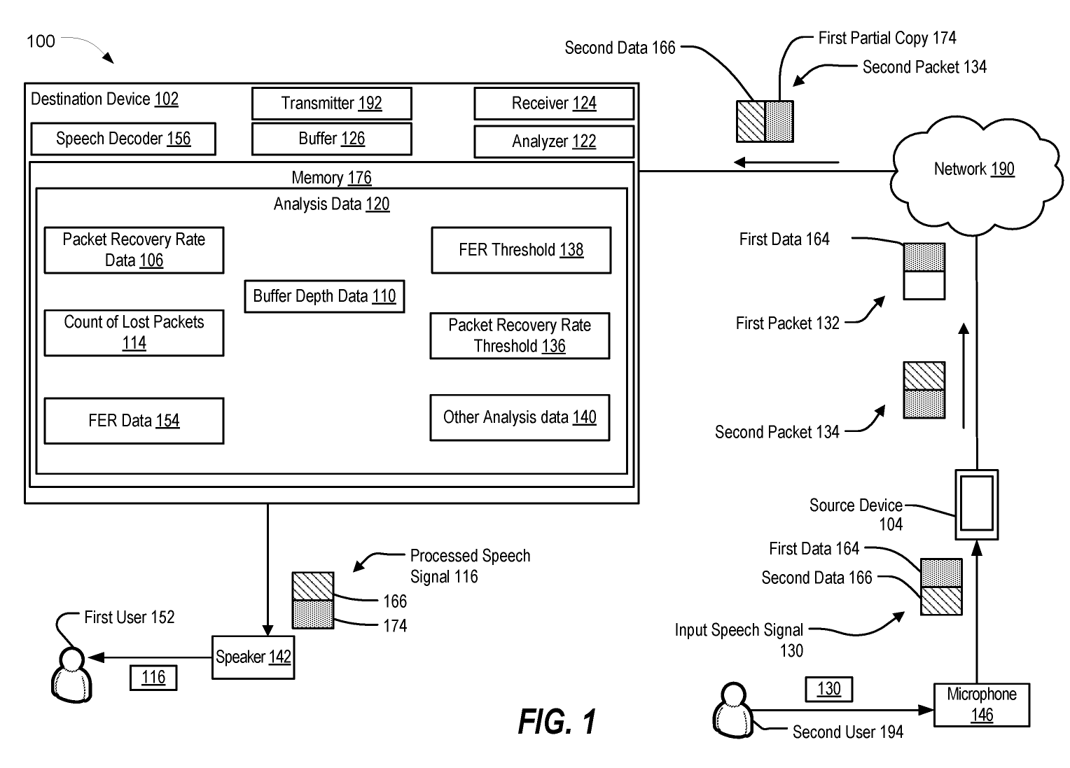

Referring to FIG. 1, a particular illustrative implementation of a system operable to perform jitter buffer management is disclosed and generally designated 100. The system 100 may include a destination device 102 (e.g., a receiving terminal) in communication with one or more other devices (e.g., a source device 104 or transmitting terminal) via a network 190. The source device 104 may include or may be coupled to a microphone 146. The destination device 102 may include or may be coupled to a speaker 142. The destination device 102 may include an analyzer 122 coupled to, or in communication with, a memory 176. The destination device 102 may include a receiver 124, a transmitter 192, a buffer 126, a speech decoder 156, or a combination thereof.

The memory 176 may be configured to store analysis data 120. The analysis data 120 may include packet recovery rate data 106, a buffer depth data 110, a count of lost packets 114, frame erasure rate (FER) data 154, a first threshold (e.g., a packet recovery rate threshold 136), a second threshold (e.g., a FER threshold 138), other analysis data 140, or a combination thereof. The packet recovery rate data 106 may indicate a rate at which lost packets are “recovered” by use of partial copies. For example, if a particular packet (or frame) transmitted by the source device 104 is lost during transmission and a subsequent packet stored in the buffer 126 includes a partial copy of the particular packet, the speech decoder 156 may use the subsequent packet to “recover” (or regenerate) the particular packet and the rate at which lost packets are recovered may increase. The buffer depth data 110 may indicate a depth of a jitter buffer, such as the buffer 126. The depth may be analogous to the size of the buffer 126, the delay (e.g., the playout delay) of the buffer 126, or both. The analyzer 122 may cause a delay of the buffer 126 may be changed (e.g., increased or decreased) by changing a value of the buffer depth data 110. The FER data 154 may indicate an error rate of packets (or frames) received by the destination device 102. According to one implementation, the error rate may be expressed as the number of packets received with errors divided by the total number of packets received. According to another implementation, the error rate may be expressed as the number of packets (or frames) lost during transmission (e.g., not received by the destination device 102) divided by the total number of packets (or frames) transmitted by the source device 104.

The destination device 102 may include fewer or more components than illustrated in FIG. 1. For example, the destination device 102 may include one or more processors, one or more memory units, or both. The destination device 102 may include a networked or a distributed computing system. For example, the memory 176 may be a networked or a distributed memory. In a particular illustrative implementation, the destination device 102 may include a communication device, a decoder, a smart phone, a cellular phone, a mobile communication device, a laptop computer, a computer, a tablet, a personal digital assistant (PDA), a set top box, a video player, an entertainment unit, a display device, a television, a gaming console, a music player, a radio, a digital video player, a digital video disc (DVD) player, a tuner, a camera, a navigation device, or a combination thereof. Such devices may include a user interface (e.g., a touch screen, voice recognition capability, or other user interface capabilities).

During operation, a first user 152 may be engaged in a voice call with a second user 194. The first user 152 may use the destination device 102 and the second user 194 may use the source device 104 for the voice call. During the voice call, the second user 194 may speak into the microphone 146 associated with the source device 104. An input speech signal 130 may correspond to a portion of a word, a word, or multiple words spoken by the second user 194. For example, the input speech signal 130 may include first data 164 and second data 166. The first data 164 and the second data 166 may be pulse code modulated (PCM) data or analog data. The source device 104 may receive the input speech signal 130, via the microphone 146, from the second user 194. In a particular implementation, the microphone 146 may capture an audio signal and an analog-to-digital converter (ADC) may convert the captured audio signal from an analog waveform into a digital waveform comprised of digital audio samples. The digital audio samples may be processed by a digital signal processor. A gain adjuster may adjust a gain (e.g., of the analog waveform or the digital waveform) by increasing or decreasing an amplitude level of an audio signal (e.g., the analog waveform or the digital waveform). Gain adjusters may operate in either the analog or digital domain. For example, a gain adjuster may operate in the digital domain and may adjust the digital audio samples produced by the analog-to-digital converter. After gain adjusting, an echo canceller may reduce echo that may have been created by an output of a speaker entering the microphone 146. The digital audio samples may be “compressed” by a vocoder (a voice encoder-decoder). The output of the echo canceller may be coupled to vocoder pre-processing blocks, e.g., filters, noise processors, rate converters, etc. An encoder of the vocoder may compress the digital audio samples and form a sequence of packets (e.g., a first packet 132 and a second packet 134). Each of the sequence of packets may include a representation of the compressed bits of the digital audio samples. For example, the first packet 132 may be earlier in the sequence of packets than the second packet 134. To illustrate, the first packet 132 may include a digitized representation of the first data 164 corresponding to a particular audio frame (e.g., an audio frame N) and the second packet 134 may include a digitized representation of the second data 166 corresponding to a subsequent audio frame (e.g., an audio frame N+2). For example, the digitized representations of the first data 164 and the second data 166 may be in the form of a compressed bit stream.

In a particular implementation, a subsequent packet (e.g., the second packet 134) may also include redundant data (e.g., a partial copy of the first packet 132) that may be used to reconstruct a previous audio frame (e.g., the audio frame N). For example, the second packet 134 may include a first partial copy 174 corresponding to at least a portion of the first data 164. In a particular implementation, the redundant data (e.g., the first partial copy 174) may correspond to a “critical” speech frame. For example, a loss of the critical speech frame may cause a user-perceptible degradation in audio quality of a processed speech signal generated at the destination device 102.

In a particular implementation, the source device 104 and the destination device 102 may operate on a constant-bit-rate (e.g., 13.2 kilobit per second (kbps)) channel. In this implementation, a primary frame bit-rate corresponding to primary data (e.g., the second data 166) may be reduced (e.g., to 9.6 kbps) to accommodate the redundant data (e.g., the first partial copy 174). For example, a remaining bit-rate (e.g., 3.6 kbps) of the constant-bit-rate may correspond to the redundant data. In a particular implementation, the reduction of the primary frame bit-rate may be performed at the source device 104 depending on characteristics of the input speech signal 130 to have reduced impact on overall speech quality.

The source device 104 may transmit the sequence of packets (e.g., the first packet 132, the second packet 134, or both) to the destination device 102 via the network 190, such as the second packet 134 illustrated as being received at the destination device 102 from the network 190. For example, the source device 104 may include a transceiver. The transceiver may modulate some form of the sequence of packets (e.g., other information may be appended to the packets 132 and 134). The transceiver may send the modulated information over the air via an antenna.

The analyzer 122 of the destination device 102 may receive one or more packets (e.g., the first packet 132, the second packet 134, or both) of the sequence of packets. For example, an antenna of the destination device 102 may receive some form of incoming packets that include the first packet 132, the second packet 134, or both. The first packet 132, the second packet 134, or both, may be “uncompressed” by a decoder of a vocoder at the destination device 102. The uncompressed waveform may be referred to as reconstructed audio samples. The reconstructed audio samples may be post-processed by vocoder post-processing blocks and an echo canceller may remove echo based on the reconstructed audio samples. For the sake of clarity, the decoder of the vocoder and the vocoder post-processing blocks may be referred to as a vocoder decoder module. In some configurations, an output of the echo canceller may be processed by the analyzer 122. Alternatively, in other configurations, the output of the vocoder decoder module may be processed by the analyzer 122.

The analyzer 122 may store the packets (e.g., the first packet 132, the second packet 134, or both) received by the destination device 102 in the buffer 126 (e.g., a jitter buffer). In a particular implementation, the packets may be received out-of-order at the destination device 102. The analyzer 122 may reorder one or more packets in the buffer 126 if the packets are out-of-order. One or more packets of the sequence of packets sent by the source device 104 may not be received, or may be received with errors, by the destination device 102. For example, a packet (e.g., the first packet 132) may not be received due to packet loss or may be partially received, due to network conditions, by the receiver 124.

The analyzer 122 may determine whether a particular packet of the sequence of packets is missing from the buffer 126. For example, each packet in the buffer 126 may include a sequence number. The analyzer 122 may maintain a counter (e.g., a next sequence number) in the analysis data 120. For example, the next sequence number may have a starting value (e.g., 0). The analyzer 122 may update (e.g., increment by 1) the next sequence number after processing each packet corresponding to a particular input signal (e.g., the input speech signal 130). The analyzer 122 may reset the next sequence number to the starting value after processing a last packet corresponding to the particular input signal (e.g., the input speech signal 130).

The analyzer 122 may determine that the buffer 126 includes a next packet (e.g., the first packet 132) having the next sequence number. The analyzer 122 may generate a processed speech signal based on at least the next packet (e.g., the first packet 132). In a particular implementation, the analyzer 122 may provide the first packet 132 to the speech decoder 156 and the speech decoder 156 may generate the processed speech signal. The analyzer 122 (or the speech decoder 156) may generate the processed speech signal based on the first packet 132 and the second packet 134. The processed speech signal may correspond to the first data 164 of the first packet 132 and the second data 166 of the second packet 134. The analyzer 122 (or the speech decoder 156) may output the processed speech signal via the speaker 142 to the first user 152. The analyzer 122 may update (e.g., increment or reset) the next sequence number.

The analyzer 122 may be configured to determine a partial frame recovery rate of lost frames at the destination device 102 (e.g., the receiving terminal). As used herein, the “partial frame recovery rate” may indicate a rate at which lost packets are “recovered” by use of partial copies. For example, if a particular packet (or frame) transmitted by the source device 104 is lost during transmission and another packet (e.g., a subsequent packet or a previous packet) stored in the buffer 126 includes a partial copy of the particular packet, the speech decoder 156 may use the other packet to “recover” (or regenerate) the particular packet and the rate (e.g., the “partial frame recovery rate”) at which lost packets are recovered may increase. The analyzer 122 may retrieve the packet recovery rate data 106 and determine the partial frame recovery rate based on the packet recovery rate data 106. The analyzer 122 may be configured to adjust the delay of the buffer 126 based at least on the partial frame recovery rate. To illustrate, the analyzer 122 may compare the partial frame recovery rate to the packet recovery rate threshold 136 (e.g., the first threshold). If the partial frame recovery rate fails to satisfy the packet recovery rate threshold 136, the delay of the buffer 126 may be increased to store additional packets, and thus to increase the partial frame recovery rate. According to one implementation, in response to the partial frame recovery rate satisfying the packet recovery rate threshold, the delay of the buffer 126 may be decreased to improve latency.

The analyzer 122 may also be configured to determine a frame erasure rate for frames received at the destination device 102. As used herein, the “frame erasure rate” may indicate a rate at which packets are unsuccessfully decoded at the destination device 102. As a non-limiting example, the frame erasure rate may be expressed as the number of frames lost during transmission (or received with errors) that are not regenerated using redundancy data, divided by the total number frames transmitted by the source device 104. The analyzer 122 may retrieve the FER data 154 and determine the frame erasure rate based on the FER data 154. To illustrate, the analyzer 122 may compare the frame erasure rate to the FER threshold 138 (e.g., the second threshold). According to one implementation, the FER threshold 138 may be based on an EVS specification. For example, the FER threshold 138 may correspond to the maximum frame erasure rate to maintain a communication session according to the EVS specification. In response to the frame erasure rate satisfying the FER threshold 138, the delay of the buffer 126 may be increased to store additional packets, and thus to decrease the frame erasure rate.

The increase in the delay (or size) of the buffer 126 may be based on (e.g., may be a function of) the partial frame recovery rate. In some implementations, a level of jitter of packets (e.g., an amount of variation in packet arrival delays) may be used to adjust the depth of the buffer 126. Below, is a non-limiting example of condition that may be used to determine whether late partial frames are used in a jitter computation. It should be understood that the equation is not to be construed as limiting, and other equations (or expressions) may be used in the determination. As a non-limiting example, the condition may be expressed as:
If (arrival time of the partial frame N<[playout_time_of_partial_frame_N+k1*(max(X,FER_rate)−X)*(1-K2*[Y−min(Y, partial_frame_recovery_rate)])]).

If the condition in the above equation is satisfied, late partial frames may be used in the jitter computation. If the condition is not satisfied, late partial frames are not used in the jitter computation. If late partial frames are used in the jitter computation, the delay is increased. According to the above equation, k1 may be a constant, Y may correspond to a threshold partial copy recovery rate to start the adjustment, and X may correspond to the threshold frame erasure rate. According to one implementation of the above equation, if T₁<T_{playout}+k1 * [Y-min(Y,R)], then frame N is used for the playout delay determination, where T₁ is the arrival time of frame N, T_{playout} is the playout time of frame N, Y is the minimum required partial frame recovery rate, and R is the current partial frame recovery rate. If R>Y, the above equation becomes T₁<T_{playout}+k1*[Y−R]. Thus, if Y equals 50 percent and R equals 20 percent, the playout delay will be increased. If Y equals 50 percent and R equals 70 percent, the playout delay will not be increased. If T₁<T_{playout}+k1*[max(X,L)−X}* [Y−min(Y,R)], the partial frames in the playout delay determination may be used. If R equal 30 percent, L=5 percent, X equals 2 percent, and Y equals 50 percent, then the playout delay will be increased. According to one implementation, the delay of the buffer 126 may have a maximum value to substantially limit effects on latency.

The analyzer 122 may determine whether a particular packet (e.g., the first packet 132) of the sequence of packets sent by the source device 104 is missing from the buffer 126. For example, the analyzer 122 may determine that the first packet 132 is missing based on determining that the buffer 126 does not store a next packet (e.g., the first packet 132) having the next sequence number. To illustrate, the analyzer 122 may determine that the first packet 132 is missing in response to determining that a packet (e.g., the first packet 132) corresponding to the next sequence number is not found in the buffer 126.

The analyzer 122 may determine whether a partial copy of the first packet 132 is stored in the buffer 126 as error correction data in another packet (e.g., the second packet 134) stored in the buffer 126. For example, one or more fields in a header of each packet may indicate whether the packet includes error correction data and may indicate a corresponding packet. The analyzer 122 may examine the particular field of one or more packets (e.g., the second packet 134) stored in the buffer 126. For example, the buffer 126 may store the second packet 134. A particular field in the header of the second packet 134 may indicate that the second packet 134 includes error correction data corresponding to the first packet 132. For example, the particular field may indicate a sequence number of the first packet 132. The analyzer 122 may determine that the partial copy of the first packet 132 is stored in the buffer 126 based on determining that the particular field of the second packet 134 indicates the sequence number of the first packet 132.

The analyzer 122 may generate a processed speech signal 116 based on at least the next packet (e.g., the second packet 134). For example, the analyzer 122 may generate the processed speech signal 116 based on the first partial copy 174 and the second data 166. The first partial copy 174 may include at least a portion of the first data 164 of the first packet 132. In a particular implementation, the first data 164 may correspond to first speech parameters of a first speech frame. The first partial copy 174 may include the first speech parameters. In a particular implementation, the second data 166 may correspond to second speech parameters of a second speech frame and the first partial copy 174 may correspond to a difference between the first speech parameters and the second speech parameters. In this implementation, the analyzer 122 may generate the first speech parameters based on a sum of the second speech parameters and the first partial copy 174.

The analyzer 122 may generate the processed speech signal 116 based on the first speech parameters. It will be appreciated that having the first partial copy 174 as error correction data in the second packet 134 may enable generation of the processed speech signal 116 based on the first speech parameters of the particular speech frame even when the first packet 132 corresponding to the particular speech frame is missing from the buffer 126.

In a particular implementation, the analyzer 122 may provide the first partial copy 174, the second packet 134, or the first speech parameters to the speech decoder 156 and the speech decoder 156 may generate the processed speech signal 116. The analyzer 122 (or the speech decoder 156) may output the processed speech signal 116 via the speaker 142 to the first user 152. The analyzer 122 may update (e.g., increment or reset) the next sequence number. The processed speech signal 116 may have a better audio quality than a processed speech signal generated based only on the second data 166. For example, the processed speech signal 116 generated based on the first partial copy 174 and the second data 166 may have fewer user perceptible artifacts than the processed speech signal generated based on the second data 166 and not based on the first data 164 (or the first partial copy 174).

In a particular implementation, the analyzer 122 may determine that the first packet 132 and the second packet 134 are missing from the buffer 126. For example, the analyzer 122 may determine that the first packet 132 is missing from the buffer 126 and that the buffer 126 does not store the partial copy of the first packet 132 as error correction data in another packet. To illustrate, the analyzer 122 may determine that the sequence number of the first packet 132 is not indicated by the particular field of any of the packets corresponding to the input speech signal 130 that are stored in the buffer 126. The analyzer 122 may update the count of lost packets 114 based on determining that the first packet 132 and the second packet 134 are missing from the buffer 126. In a particular implementation, the analyzer 122 may update (e.g., increment by 1) the count of lost packets 114 to reflect that the first packet 132 is missing from the buffer 126 and that the buffer 126 does not store a packet (e.g., the second packet 134) that includes a partial copy of the first packet 132. The analyzer 122 may update (e.g., increment or reset) the next sequence number.

According to one implementation, the first packet 132 may include a first sequence number (e.g., a first generation timestamp) and the second packet 134 may include a second sequence number (e.g., a second generation timestamp). The first generation timestamp may indicate a first time at which the first packet 132 is generated by the source device 104 and the second generation timestamp may indicate a second time at which the second packet 134 is generated by the source device 104. The first partial copy 174 may include the first sequence number (e.g., the first generation timestamp).

Each packet that is received by the destination device 102 may be assigned a receive timestamp by the receiver 124, the analyzer 122, or by another component of the destination device 102. For example, the second packet 134 may be assigned a second receive timestamp. The analyzer 122 may determine a first receive timestamp based on the second receive timestamp and may assign the first receive timestamp to the first partial copy 174. The first receive timestamp may be the same as or distinct from the second receive timestamp. For example, the first receive timestamp may indicate a first receive time that is earlier than a second receive time indicated by the second receive timestamp. In this example, the first receive time may correspond to an estimated time at which the first packet 132 would have been received in a timely manner. To illustrate, the first receive time may correspond to an estimated receive time of the first packet 132 if the first packet 132 had not been delayed or lost.

The analyzer 122 may process a packet based on a receive timestamp associated with the packet, the buffer delay, a buffer timeline, and a last played packet, as described herein. The buffer delay may correspond to a threshold time that a packet is to be stored in the buffer 126. For example, the buffer delay may indicate a first threshold time (e.g., 5 milliseconds). A packet may be received at a first receive time (e.g., 1:00:00.000 PM). A receive timestamp indicating the first receive time may be associated with the packet. A second time (e.g., 1:00:00.005 PM) may correspond to a sum of the first receive time indicated by the receive timestamp and the buffer delay. The packet may be processed at or subsequent to the second time.

The buffer timeline may indicate a next packet to be processed. For example, the buffer timeline may indicate a sequence number of a particular packet that was most recently processed from the buffer 126 or for which an erasure was most recently played. To illustrate, the analyzer 122 may update the buffer timeline to indicate a first sequence number of a packet in response to processing the packet from the buffer 126, processing a partial copy of the packet from the buffer 126, or playing an erasure corresponding to the packet. In this example, the analyzer 122 may determine a next sequence number of the next packet to be processed based on the sequence number (e.g., the first sequence number) indicated by the buffer timeline.

The last played packet may indicate the particular packet that was most recently processed from the buffer 126. Processing the particular packet from the buffer 126 may include processing the particular packet from the buffer 126 or processing a partial copy of the particular packet from the buffer 126. The analyzer 122 may update the last played packet to indicate a first sequence number of a packet in response to processing the packet from the buffer 126 or processing a partial copy of the packet from the buffer 126.

The analyzer 122 may determine that the last played packet indicates a previous packet that was most recently processed from the buffer 126 by the analyzer 122. The analyzer 122 may determine that a particular packet (e.g., the first packet 132) is subsequent to the previous packet in the sequence of packets. The analyzer 122 may determine whether a next packet to be processed indicated by the buffer timeline is the same as or subsequent to the first packet 132 in the sequence of packets. The analyzer 122 may, at approximately a first playback time, play an erasure in response to determining that the next packet to be processed, as indicated by the buffer timeline, is prior to the first packet 132 in the sequence of packets.

The analyzer 122 may update the buffer timeline subsequent to playing the erasure. For example, the buffer timeline may, prior to the erasure being played, indicate that a first particular packet is the next packet to be processed. The analyzer 122 may, subsequent to playing the erasure, update the buffer timeline to indicate that a second particular packet is the next packet to be processed. The second particular packet may be next after the first particular packet in the sequence of packets.

Alternatively, the analyzer 122 may, in response to determining that the next packet to be processed indicated by the buffer timeline is the same as or subsequent to the first packet 132 in the sequence of packets, determine whether the buffer 126 stores the first packet 132 (or the first partial copy 174). The analyzer 122 may, in response to determining that the buffer 126 stores the first partial copy 174, determine that the first partial copy 174 is associated with the first receive timestamp indicating the first receive time. The analyzer 122 may, at approximately the first playback time, process the first partial copy 174 from the buffer 126 in response to determining that the first time is greater than or equal to a sum of the first receive time and the buffer delay. The buffer delay may correspond to a threshold time that a packet is to be stored in the buffer 126. In a particular implementation, the analyzer 122 may process the first partial copy 174 irrespective of whether the first partial copy 174 has been stored in the buffer 126 for the threshold time. In this implementation, the first receive time may be earlier than the second receive time. For example, the first receive time may correspond to an expected receive time of the first packet 132 if the first packet 132 had been received in a timely manner. The analyzer 122 may process the first partial copy 174 at approximately the first playback time in response to determining that the first packet 132 would have been stored in the buffer 126 for at least the threshold time if the first packet 132 had been received in the timely manner. The buffer delay may include a default value, may be based on user input from the first user 152, or both. The analyzer 122 may adjust the buffer delay, as described herein. The analyzer 122 may, subsequent to processing the first partial copy 174 from the buffer 126, update the last played packet to indicate the first packet 132 and may update the buffer timeline to indicate a second particular packet (e.g., the second packet 134) as the next packet to be processed. The second particular packet (e.g., the second packet 134) may be next after the first packet 132 in the sequence of packets.

In a particular implementation, the analyzer 122 may, in response to determining that the first packet 132 and the first partial copy 174 are missing from the buffer 126, perform a similar analysis on the second particular packet (e.g., the second packet 134) as performed on the first packet 132. For example, the analyzer 122 may play an erasure in response to determining that the next packet to be processed indicated by the buffer timeline is prior to the second particular packet in the sequence of packets and may update the buffer timeline subsequent to playing the erasure. Alternatively, the analyzer 122 may, at approximately the first playback time, process the second particular packet from the buffer 126 in response to determining that the next packet to be processed indicated by the buffer timeline is the same as or subsequent to the second particular packet, that the second particular packet or a partial copy of the second particular packet is stored in the buffer 126, and that the first playback time is greater than or equal to a sum of the buffer delay and a particular receive time associated with the second particular packet.

The destination device 102 may receive the sequence of packets (e.g., the first packet 132, the second packet 134, or both) during a phone call. The first packet 132, the second packet 134, or both, may include speech data. The analyzer 122 may determine or update the buffer delay, as described herein, at a beginning of a talk spurt or at an end of the talk spurt during the phone call. A talk spurt may correspond to a continuous segment of speech between silent intervals during which background noise may be heard. For example, a first talk spurt may correspond to speech of the first user 152 and a second talk spurt may correspond to speech of the second user 194. The first talk spurt and the second talk spurt may be separated by a period of silence or background noise.

The analyzer 122 may determine a previous delay loss rate. As used herein, a “delay loss rate” is computed on a past window of frames. If a frame arrives after its playout time, then the frame is a “delay loss frame”. The delay loss rate may be expressed as the number of delay loss frames divided by the total number of frames transmitted. The previous delay loss rate may correspond to a delay loss rate determined during a previous adjustment of the buffer delay at a first update time. The analyzer 122 may maintain a count of delay loss packets. The count of delay loss packets may indicate a number of packets that are received subsequent to processing of partial copies of the packets from the buffer 126 at corresponding playback times. The corresponding playback times may be subsequent to the first update time. For example, the analyzer 122 may, subsequent to the first update time, process the first partial copy 174 from the buffer 126 at a first playback time associated with the first packet 132. The analyzer 122 may determine that a first time corresponds to the first playback time based on determining that one or more conditions are satisfied. For example, the first time may correspond to the first playback time if, at the first time, the last played packet is prior to the first packet 132 and the first packet 132 is prior to or the same as the next packet to be processed as indicated by the buffer timeline. The first time may correspond to the first playback time if the first time is greater than or equal to a sum of a receive time associated with the first packet 132 (e.g., the first receive time of the first partial copy 174) and the buffer delay. The first time may correspond to the first playback time if the first packet 132 is the earliest packet in the sequence of packets that satisfies the preceding conditions at the first time. The analyzer 122 may update (e.g., increment) the count of delay loss packets in response to receiving the first packet 132 subsequent to processing the first partial copy 174.

The analyzer 122 may maintain a received packets count. For example, the analyzer 122 may reset the received packets count subsequent to the first update time. The analyzer 122 may update (e.g., increment by 1) the received packets count in response to receiving a packet (e.g., the second packet 134). The analyzer 122 may determine a second delay loss rate based on the count of delay loss packets and the received packets count. For example, the second delay loss rate may correspond to a measure (e.g., a ratio) of the count of delay loss packets and the received packets count. To illustrate, the second delay loss rate may indicate an average number of delay loss packets (e.g., packets that are received subsequent to processing of partial copies of the packets) during a particular time interval. The second delay loss rate may indicate network jitter during the particular time interval. A difference between the previous delay loss rate and the second delay loss rate may indicate a variation in delay of received packets. The difference between the previous delay loss rate and the second delay loss rate may indicate whether the average number of delay loss packets is increasing or decreasing.

The analyzer 122 may determine a delay loss rate based on the previous delay loss rate and the second delay loss rate. For example, the delay loss rate may correspond to a weighted sum of the previous delay loss rate and the second delay loss rate. The analyzer 122 may assign a first weight (e.g., 0.75) to the previous delay loss rate and a second weight (e.g., 0.25) to the second delay loss rate. The first weight may be the same as or distinct from the second weight. In a particular implementation, the first weight may be higher than the second weight. Determining the delay loss rate based on the weighted sum of the previous delay loss rate and the second delay loss rate may reduce oscillation in the delay loss rate based on temporary network conditions.

For example, bundling of packets may cause a large number of packets (e.g., 3) to arrive at the same time followed by no packet arrivals during a subsequent interval. The second delay loss rate may fluctuate from a first time to a second time because the second delay loss rate determined at the first time may correspond to an interval during which a large number of packets is received and the second delay loss rate determined at the second time may correspond to an interval with no packet arrivals. Determining the delay loss rate based on the weighted sum of the previous delay loss rate and the second delay loss rate may reduce an effect of packet bundling on the delay loss rate.

The analyzer 122 may increase the buffer delay by an increment amount (e.g., 20 milliseconds) in response to determining that the delay loss rate fails to satisfy (e.g., is less than) a target delay loss rate (e.g., 0.01). For example, the target delay loss rate may correspond to a first percent (e.g., 1 percent) of delay loss packets relative to received packets. The analyzer 122 may decrease the buffer delay by a decrement amount (e.g., 20 milliseconds) in response to determining that the delay loss rate satisfies (e.g., is greater than) the target delay loss rate, that the delay loss rate is greater than or equal to the previous delay loss rate, or both. The decrement amount, the increment amount, the target delay loss rate, or a combination thereof, may include default values, may be based on user input from the first user 152, or both. The decrement amount may be the same as or distinct from the increment amount.

The analyzer 122 may set the buffer delay to a maximum of the buffer delay and a delay lower limit (e.g., 20 milliseconds). For example, the analyzer 122 may set the buffer delay to the delay lower limit in response to determining that the buffer delay is lower than the delay lower limit. The analyzer 122 may set the buffer delay to a minimum of the buffer delay and a delay upper limit (e.g., 80 milliseconds). For example, the analyzer 122 may set the buffer delay to the delay upper limit in response to determining that the buffer delay exceeds the delay upper limit. The delay lower limit, the delay upper limit, or both, may be default values, may be based on user input from the first user 152, or both.

The system 100 of FIG. 1 may enable partial recovery of data of a lost packet without retransmission of the lost packet. For example, the analyzer 122 may dynamically adjust the delay of the buffer 126 based on the partial frame recovery rate at the destination device 102 and based on the frame erasure rate at the destination device 102 to increase the likelihood that a partial copy of a lost packet is in the buffer 126 when the speech decoder 156 attempts to decode the lost packet. The techniques described with respect to FIG. 1 may enable the playout delay to be adapted based on the partial frame recovery rate and based on the frame erasure rate. Late partial frames may also be used in the playout delay determination. For example, late partial frames may be used to compute the jitter, the delay loss rate, or both. According to some implementations, late partial frames within a particular duration after a corresponding playout time may be used to compute the jitter, the delay loss rate, or both.

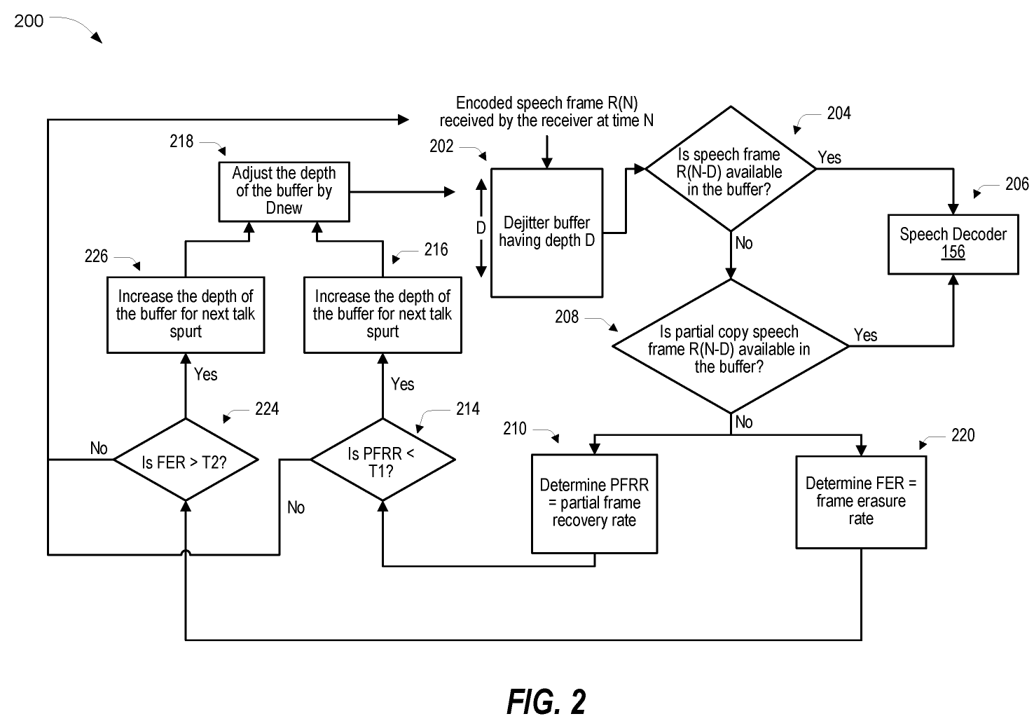

Referring to FIG. 2, a particular illustrative implementation of a method for adjusting a delay of a buffer at a receiving terminal is disclosed and generally designated 200. In a particular implementation, the method 200 may be performed by the analyzer 122 of FIG. 1. FIG. 2 illustrates adjustment of the buffer depth 110 of FIG. 1 based on the partial frame recovery rate, the frame erasure rate, or both. For example, the adjustment (D) of the buffer depth 110 may be a function (f) of the partial frame recovery rate (PFRR) and the frame erasure rate (FER) (e.g., D=f(PFRR, FER)).

The method 200 includes receiving, by a receiver, an encoded speech frame R(N) at time N, at 202. For example, the receiver 124 of FIG. 1 may receive a particular packet corresponding to a particular audio frame of the input speech signal 130, as described with reference to FIG. 1.

The method 200 also includes determining whether a next speech frame R(N-D) is available in a buffer, at 204. For example, the analyzer 122 may determine whether a next packet is stored in the buffer 126, as described with reference to FIG. 1. The next packet may have a next sequence number. In a particular implementation, the analyzer 122 may determine the next sequence number by incrementing a sequence number of a previously processed packet. In an alternative implementation, the analyzer 122 may determine the next sequence number based on a difference between a sequence number of a most recently received packet (e.g., N) and the buffer depth 110 (e.g., D). In this implementation, the buffer depth 110 may indicate a maximum number of packets that are to be stored in the buffer 126. The analyzer 122 may determine whether the next packet (e.g., the first packet 132) corresponding to the next sequence number is stored in the buffer 126.

The method 200 further includes, in response to determining that the next speech frame R(N-D) is available in the jitter buffer, at 204, providing the next speech frame R(N-D) to a speech decoder, at 206. For example, the analyzer 122 may, in response to determining that the next packet (e.g., the first packet 132) is stored in the buffer 126, provide the first packet 132 to the speech decoder 156, as described with reference to FIG. 1.

The method 200 also includes, in response to determining that the next speech frame R(N-D) is unavailable in the jitter buffer, at 204, determining whether a partial copy of the next speech frame R(N-D) is available in the jitter buffer, at 208. For example, the analyzer 122 of FIG. 1 may, in response to determining that the first packet 132 is not stored in the buffer 126, determine whether a partial copy of the first packet 132 is stored in the buffer 126, as described with reference to FIG. 1. To illustrate, the analyzer 122 may determine whether the second packet 134 that has the first partial copy 174 is stored in the buffer 126.

The method 200 further includes, in response to determining that the partial copy of the next speech frame R(N-D) is available in the jitter buffer, at 208, providing the partial copy of the next speech frame R(N-D) to the speech decoder, at 206. For example, the analyzer 122 of FIG. 1 may, in response to determining that the second packet 134 is included in the buffer 126 and that the second packet 134 includes the first partial copy 174 of the first packet 132, provide the second packet 134 to the speech decoder 156. In a particular implementation, the analyzer 122 may provide the first partial copy 174 to the speech decoder 156.

The method 200 also includes, in response to determining that the partial copy of the next speech frame R(N-D) is unavailable in the jitter buffer, at 208, determining the “average” partial frame recovery rate (PFRR), at 210, and determining the “average” frame erasure rate (FER), at 220. According to some implementations, the PFRR may be a primary determination and the FER may be a secondary determination. For example, the determination whether to increase the delay (e.g., the buffer depth) may be based on a function of the PFRR or based on a function of the PFRR and the FER. Thus, according to some implementations, the method 200 of FIG. 2 may be modified such that the PFRR is used as a primary (or sole) factor in the determination whether to modify the delay and the FER is used a secondary factor (if at all) in the determination whether to modify the delay. The analyzer 122 may retrieve the packet recovery rate data 106 and determine the partial frame recovery rate based on the packet recovery rate data 106. The analyzer 122 may also retrieve the FER data 154 and determine the frame erasure rate based on the FER data 154.

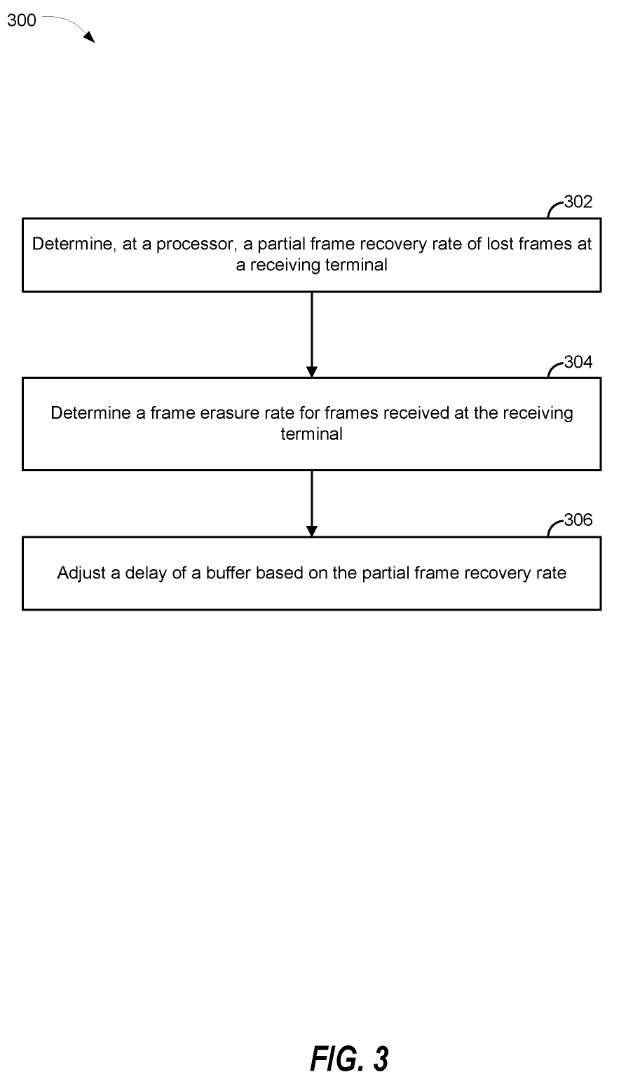

The method 200 further includes comparing the partial frame recovery rate to the first threshold (T1), at 214. To illustrate, the analyzer 122 may compare the partial frame recovery rate to the packet recovery rate threshold 136 (e.g., the first threshold). If the partial frame recovery rate is less than the first threshold (T1), at 214, the depth of the buffer may be increased for the next talk spurt, at 216. To illustrate, in response to the partial frame recovery rate failing to satisfy the packet recovery rate threshold 136, the delay of the buffer 126 may be increased to store additional packets, and thus to increase the partial frame recovery rate. According to one implementation, the delay of the buffer 126 may have a maximum value to substantially limit effects on latency regardless of the determination, at 214. If the partial frame recovery rate is not less than the first threshold (T1), at 214, the delay of the buffer may remain constant (or may be decremented). It should be understood that comparing the partial frame recovery rate to the first threshold (T1), at 214, is not to be construed as a limiting, and other techniques may be used to determine whether to increase the delay (e.g., the buffer size), as described with respect to FIG. 3.

The method 200 further includes comparing the frame erasure rate to the second threshold (T2), at 224. To illustrate, the analyzer 122 may compare the frame erasure rate to the FER threshold 138 (e.g., the second threshold). According to one implementation, the FER threshold 138 may be based on an EVS specification. For example, the FER threshold 138 may correspond to the maximum frame erasure rate to maintain a communication session according to the EVS specification. If the frame erasure rate is greater than the second threshold (T2), at 214, the depth of the buffer may be increased for the next talk spurt, at 226. To illustrate, in response to the frame erasure rate satisfying the FER threshold 138, the delay of the buffer 126 may be increased to store additional packets, and thus to decrease the frame erasure rate. If the frame erasure rate is not greater than the second threshold (T2), at 224, the delay of the buffer may remain constant (or may be decremented). According to some implementations, the method 200 may include comparing the partial frame recover rate to the first threshold (T1), at 214, and comparing the frame erasure rate to the second threshold (T2), at 224. In response to the partial frame recovery rate failing to satisfy the first threshold (T1) and the frame erasure rate satisfying the second threshold (T2), the delay of the buffer may be increased, at 218. It should be understood that comparing the frame erasure rate to the second threshold (T2), at 224, is not to be construed as a limiting, and other techniques may be used to determine whether to increase the delay (e.g., the buffer size), as described with respect to FIG. 3.

At 218, the depth (e.g., the size, the delay, or both) of the buffer may be increased to by an adjustment amount (Dnew) in response to the partial frame recovery rate failing to satisfy the first threshold (T1), in response to the frame erasure rate satisfying the second threshold (T2), or both. For example, the analyzer 122 of FIG. 1 may adjust the buffer depth 110 based on the adjustment amount (e.g., D_{new}). The method 200 may proceed to 202.

The method 200 of FIG. 2 may enable partial recovery of data of a lost packet without retransmission of the lost packet. For example, the analyzer 122 may dynamically adjust the delay of the buffer 126 based on the partial frame recovery rate at the destination device 102 and based on the frame erasure rate at the destination device 102 to increase the likelihood that a partial copy of a lost packet is in the buffer 126 when the speech decoder 156 attempts to decode the lost packet.

Referring to FIG. 3, a flow chart of a particular illustrative implementation of a method 300 of adjusting a delay of a buffer at a receiving terminal is shown. The method 300 may be performed by the destination device 102 of FIG. 1.

The method 300 includes determining, at a processor, a partial frame recovery rate of lost frames at a receiving terminal, at 302. For example, referring to FIG. 1, the analyzer 122 may determine the partial frame recovery rate of lost frames at the destination device 102 (e.g., the receiving terminal). To illustrate, the analyzer 122 may retrieve the packet recovery rate data 106 and determine the partial frame recovery rate based on the packet recovery rate data 106. The packet recovery rate data 106 may indicate a rate at which lost packets are “recovered” by use of partial copies. For example, if a particular packet (or frame) transmitted by the source device 104 is lost during transmission and a subsequent packet stored in the buffer 126 includes a partial copy of the particular packet, the speech decoder 156 may use the subsequent packet to “recover” (or regenerate) the particular packet and the rate at which lost packets are recovered may increase.

A frame erasure rate may be determined for frames received at the receiving terminal, at 304. For example, referring to FIG. 1, the analyzer 122 may also determine a frame erasure rate for frames received at the destination device 102. To illustrate, the analyzer 122 may retrieve the FER data 154 and determine the frame erasure rate based on the FER data 154. The FER data 154 may indicate an error rate of packets (or frames) received by the destination device 102. The error rate may be expressed as the number of packets received with errors divided by the total number of packets received.

A delay of a buffer may be adjusted based on the partial frame recovery rate, at 306. For example, referring to FIG. 1, the analyzer 122 may compare the partial frame recovery rate to the packet recovery rate threshold 136 (e.g., the first threshold). In response to the partial frame recovery rate failing to satisfy the packet recovery rate threshold 136, the delay of the buffer 126 may be increased to store additional packets, and thus to increase the partial frame recovery rate.

According to one implementation, the delay may also be adjusted based on the frame erasure rate (in addition to the partial frame recovery rate). For example, referring to FIG. 1, the analyzer 122 may compare the frame erasure rate to the FER threshold 138 (e.g., the second threshold). According to one implementation, the FER threshold 138 may be based on an EVS specification. For example, the FER threshold 138 may correspond to the maximum frame erasure rate to maintain a communication session according to the EVS specification. In response to the frame erasure rate satisfying the FER threshold 138, the delay of the buffer 126 may be increased to store additional packets, and thus to decrease the frame erasure rate.

According to one implementation, the increase in the delay (or size) of the buffer 126 may be based on (e.g., may be a function of) the frame erasure rate and based on the partial frame recovery rate. As a non-limiting example, the delay may be expressed as:
playout_time_of_partial_frame_N+k1*(max(X,FER_rate)−X)*[Y−min(Y, partial_frame_recovery_rate).

According to the above equation, k1 may be a constant, Y may correspond to a threshold partial copy recovery rate to start the adjustment, and X may correspond to the threshold frame erasure rate. According to one implementation, the delay of the buffer 126 may have a maximum value to substantially limit effects on latency.

According to one implementation, the delay of the buffer may correspond to a depth of the buffer. For example, as the depth of the buffer increases, the delay of the buffer may also increase. The delay of the buffer may be based on a function of the partial frame recovery rate, a function of the frame erasure rate, or a function of both. According to some implementations, the delay may be further adjusted based on late arriving partial frames in response to a determination that the partial frame recovery rate is below a particular threshold. The delay may also be adjusted based on late arriving partial frame. According to one implementation, the late arriving partial frames may be used in determining jitter associated with a wireless network. According to one implementation, the late arriving partial frames may be used in determining a delay loss rate.

According to one implementation, the method 300 may include determining whether a first frame is stored at the buffer. The first frame may be scheduled to be decoded during a first time period. For example, referring to FIG. 1, during a first time period, the analyzer 122 (or the speech decoder 156) may determine whether the first packet 132 is stored at the buffer 126. The first packet 132 may be scheduled to be decoded during the first time period. The method 300 may also include polling the buffer for a second frame during the first time period in response to a determination that the first frame is not stored at the buffer during the first time period. The second frame may include a partial copy of the first frame. For example, referring to FIG. 1, the analyzer 122 (or the speech decoder 156) may poll the buffer 126 for the second packet 134 during the first time period in response to a determination that the first packet 132 is not stored at the buffer 126 during the first time period. The second packet 134 may include a partial copy of the first packet 132. The method 300 may also include increasing the delay of the buffer in response to a determination that the second frame is not stored at the buffer during the first time period. For example, referring to FIG. 1, the delay of the buffer 126 may be increased in response to a determination that the second packet 134 is not stored at the buffer 126 during the first time period.

According to one implementation, the method 300 may include determining whether a partial copy of a particular frame is stored at the buffer in response to a determination that the particular frame is lost. For example, referring to FIG. 1, the analyzer 122 (or the speech decoder 156) may determine whether a partial copy of the first packet 132 is stored at the buffer 126 in response to a determination that the first packet 132 is lost. To illustrate, the analyzer 122 may determine whether the second packet 134 (that includes a partial copy of the first packet 132) is stored at the buffer 126. The method 300 may also include adjusting the delay of the buffer in response to a determination that the partial copy of the particular frame is stored at the buffer. For example, referring to FIG. 1, the delay of the buffer 126 may be adjusted in response to a determination that the second packet 134 is stored at the buffer 126. The method 300 may also include determining whether to adjust the delay of the buffer based on the partial frame recovery rate, the frame error rate, or both, in response to a determination that the partial copy of the particular frame is not stored at the buffer. For example, the referring to FIG. 1, analyzer 122 may determine whether to adjust the delay of the buffer 126 based on the partial frame recovery rate, the frame error rate, or both, in response to a determination the second packet 134 is not stored at the buffer 126.

The partial frame recovery rate may be associated with the delay of the buffer, and the delay of the buffer may be based at least in part on jitter associated with (e.g., introduced by) a wireless network (e.g., a VoLTE network or an Institute of Electrical and Electronics Engineers (IEEE) 802.11 network) or a delayed loss rate. According to one implementation, the jitter may be measured. Jitter may be the distribution of the end-to-end delay of a sequence of packets. As a non-limiting example, if the packets arrive in a VoLTE network with a mean delay of 200 ms and a standard deviation of 10 ms, the jitter may be determined to be relatively low. Alternatively, if the standard deviation is approximately 100 ms, the jitter may be determined to be relatively high. According to another implementation, the jitter may be determined based on the arrivals of packets out-of-sequence. As a non-limiting example, if the out-of-sequence arrivals are greater than a threshold (e.g., five percent), the jitter may be determined to be relatively high. Alternatively, if the out-of-sequence arrivals are less than the threshold, the jitter may be determined to be relatively low. According to another implementation, the jitter may be determined based on the delayed loss rate. For example, if the number of packets that arrive after the corresponding playout time is large, the jitter may be determined to be relatively high. To illustrate, if the delayed loss rate is less the 0.2 percent, the jitter may be determined to be relatively low. If the delayed loss rate is greater than 0.2 percent, the jitter may be determined to be relatively high.

Thus, the delay of the buffer may be based on jitter associated with a wireless network. The jitter may be based in part on late partial copies of lost primary frames. Additionally, the delay of the buffer may be based on a delay loss rate. The delay loss rate may be based in part on late partial copies of primary lost frames.

According to one implementation, the method 300 may include measuring jitter based on primary frames, based on useful partial frames, and based on late partial copies. The late partial copies may be used unconditionally, if the late partial copies arrive within 20 ms of the corresponding playout time, or if the primary frame has not arrived for delay loss computation. According to another implementation, the method 300 may include measuring jitter based on primary frames, based on useful partial frame, based on late partial copies, and based on the partial frame recovery rate. If the partial frame recovery rate is less than a first rate recovery threshold (e.g., 70 percent), the playout delay may be based on a function of the primary frames, the useful partial frame, and all of the late partial copies. If the partial frame recovery rate is less than a second rate recovery threshold, the playout delay may be based on a function of the primary frames, the useful partial frame, and late partial copies that arrive within a particular time period (e.g., 30 ms) after the playout time.

According to yet another implementation, the method 300 may include measuring jitter based on based on primary frames, based on useful partial frame, based on late partial copies, based on the partial frame recovery rate, and based on the frame erasure rate. The playout delay may be determined (e.g., computed) based on jitter measured from any of the above implementations.

According to some Jitter Buffer Management (JBM) implementations, the method 300 may include determining a buffer underflow rate (e.g., “late loss”) at the receiving terminal. The buffer underflow rate may indicate a rate that frames arrive at the receiving terminal after corresponding playout times. To illustrate, if the speech decoder 156 determines that a particular packet (e.g., the first packet 132) arrives at the destination device 102 after the playout time of the particular packet, the buffer underflow rate increases. As used herein, the playout time of the particular packet corresponds to a time period during which the speech decoder 156 is configured decode the particular packet. The method 300 may also include increasing a depth (or delay) of the buffer if the buffer underflow rate satisfies a threshold. For example, if the speech decoder 156 determines that the buffer underflow rate satisfies a particular threshold, the speech decoder 156 may increase the size of the buffer 126 (e.g., increase the delay). Increasing the delay may enable late arriving packets to be decoded and processed.

The method 300 may also include adjusting a minimum depth of the buffer or a maximum depth of the buffer based on the buffer underflow rate. For example, the buffer 126 may have minimum depth and a maximum depth (e.g., maximum delay). If the buffer underflow rate satisfies the threshold, the minimum depth (e.g., the minimum delay) of the buffer 126 may be increased to enable late arriving packets to be decoded. For example, the analyzer 122 may adjust the buffer depth 110 based on the adjustment amount described with respect to FIG. 2 to increase the minimum depth of the buffer 126.

The method 300 may also include increasing implicit buffer adaptation at the destination device 102 to reduce an occurrence of underflows that is due to delayed packets. For example, the buffer 126 may attempt to provide a particular frame (Frame N) to the speech decoder 156 for playback. Thus, the particular frame (Frame N) may be the “next to play” frame. If the particular frame (Frame N) is received after a playback time associated with the particular frame (Frame N), an erasure may be provided to the speech decoder 156 for playback. If the speech decoder 156 requests another frame to perform decoding operations and playback, the buffer 126 provides the particular frame (Frame N) (e.g., the next to play frame) to the speech decoder 156 or a subsequent frame (Frame N+1) (e.g., a “next to play plus one” frame) to the speech decoder 156. In this scenario, if the particular frame (Frame N) is present in the buffer 126, the particular frame (Frame N) is provided to the speech decoder 156. However, if the particular frame (Frame N) is not present, the subsequent frame (Frame N+1) is provided to the speech decoder 156. If both frames are present, the frame having the smaller sequence number (e.g., Frame N) is provided to the speech decoder 156. If neither frame is present, another erasure may be provided to the speech decoder 156. Thus, when an occurrence of underflows is present, the buffer 126 may provide a frame out of sequence of frames starting from (Frame N) to (Frame N+IBAₘₐₓ) to the speech decoder 156.

The method 300 of FIG. 3 may enable partial recovery of data of a lost packet without retransmission of the lost packet. For example, the analyzer 122 may dynamically adjust the delay of the buffer 126 based on the partial frame recovery rate at the destination device 102 and based on the frame erasure rate at the destination device 102 to increase the likelihood that a partial copy of a lost packet is in the buffer 126 when the speech decoder 156 attempts to decode the lost packet.

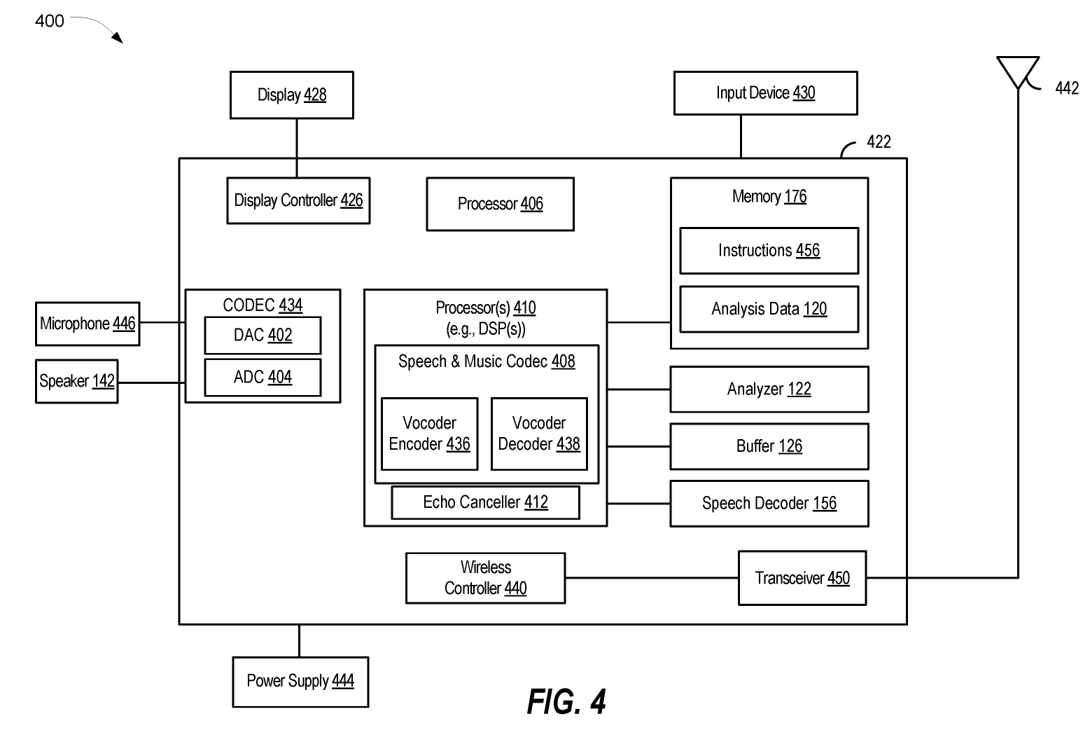

The method 300 of FIG. 3 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 300 of FIG. 3 may be performed by a processor that executes instructions, as described with respect to FIG. 4.

Referring to FIG. 4, a block diagram of a particular illustrative implementation of a device (e.g., a wireless communication device) is depicted and generally designated 400. In various implementations, the device 400 may have more or fewer components than illustrated in FIG. 4. In an illustrative implementation, the device 400 may correspond to the destination device 102, the source device 104 of FIG. 1, or both. In an illustrative implementation, the device 400 may perform one or more operations described with reference to FIGS. 1-3.

In a particular implementation, the device 400 includes a processor 406 (e.g., a central processing unit (CPU). The device 400 may include one or more additional processors 410 (e.g., one or more digital signal processors (DSPs)). The processors 410 may include a speech and music coder-decoder (CODEC) 408 and an echo canceller 412. The speech and music codec 408 may include a vocoder encoder 436, a vocoder decoder 438, or both.

The device 400 may include the memory 176 and a CODEC 434. The memory 176 may include the analysis data 120. The device 400 may include a wireless controller 440 coupled, via a transceiver 450, to an antenna 442. In a particular implementation, the transceiver 450 may include the receiver 124, the transmitter 192, or both, of FIG. 1.

The device 400 may include a display 428 coupled to a display controller 426. The speaker 142 of FIG. 1, a microphone 446, or both, may be coupled to the CODEC 434. The CODEC 434 may include a digital-to-analog converter 402 and an analog-to-digital converter 404. In an illustrative implementation, the microphone 446 may correspond to the microphone 146 of FIG. 1. In a particular implementation, the CODEC 434 may receive analog signals from the microphone 446, convert the analog signals to digital signals using the analog-to-digital converter 404, and provide the digital signals to the speech and music codec 408. The speech and music codec 408 may process the digital signals. In a particular implementation, the speech and music codec 408 may provide digital signals to the CODEC 434. The CODEC 434 may convert the digital signals to analog signals using the digital-to-analog converter 402 and may provide the analog signals to the speaker 142.

The device 400 may include the analyzer 122, the buffer 126, the speech decoder 156, or a combination thereof. In a particular implementation, the analyzer 122, the speech decoder 156, or both, may be included in the processor 406, the processors 410, the CODEC 434, the speech and music codec 408, or a combination thereof. In a particular implementation, the analyzer 122, the speech decoder 156, or both, may be included in the vocoder encoder 436, the vocoder decoder 438, or both. In a particular implementation, the speech decoder 156 may be functionally identical to the vocoder decoder 438. The speech decoder 156 may correspond to dedicated hardware circuitry outside the processors 410 (e.g., the DSPs).

The analyzer 122, the buffer 126, the speech decoder 156, or a combination thereof, may be used to implement a hardware implementation of the buffer depth adjustment techniques described herein. Alternatively, or in addition, a software implementation (or combined software/hardware implementation) may be implemented. For example, the memory 176 may include instructions 456 executable by the processors 410 or other processing unit of the device 400 (e.g., the processor 406, the CODEC 434, or both). The instructions 456 may correspond to the analyzer 122, the speech decoder 156, or both.

In a particular implementation, the device 400 may be included in a system-in-package or system-on-chip device 422. In a particular implementation, the analyzer 122, the buffer 126, the speech decoder 156, the memory 176, the processor 406, the processors 410, the display controller 426, the CODEC 434, and the wireless controller 440 are included in a system-in-package or system-on-chip device 422. In a particular implementation, an input device 430 and a power supply 444 are coupled to the system-on-chip device 422. Moreover, in a particular implementation, as illustrated in FIG. 4, the display 428, the input device 430, the speaker 142, the microphone 446, the antenna 442, and the power supply 444 are external to the system-on-chip device 422. In a particular implementation, each of the display 428, the input device 430, the speaker 142, the microphone 446, the antenna 442, and the power supply 444 may be coupled to a component of the system-on-chip device 422, such as an interface or a controller.

The device 400 may include a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, or any combination thereof.

In conjunction with the described implementations, an apparatus may include means for determining a partial frame recovery rate of lost frames at a receiving terminal. For example, the means for determining the partial frame recovery rate may include the analyzer 122 of FIG. 1, the memory 176 of FIG. 1, the packet recovery rate data 106 of FIG. 1, the analysis data 120 of FIG. 1, the speech decoder 156 of FIG. 1, the processor 406 of FIG. 4, the processor(s) 410 of FIG. 4, the CODEC 434 of FIG. 4, vocoder decoder 438 of FIG. 4, or a combination thereof.

The apparatus may also include means for determining a frame erasure rate for frames received at the receiving terminal. For example, the means for determining the frame erasure rate may include the analyzer 122 of FIG. 1, the memory 176 of FIG. 1, the FER data 154 of FIG. 1, the analysis data 120 of FIG. 1, the speech decoder 156 of FIG. 1, the processor 406 of FIG. 4, the processor(s) 410 of FIG. 4, the CODEC 434 of FIG. 4, vocoder decoder 438 of FIG. 4, or a combination thereof.

The apparatus may also include means for comparing the partial frame recovery rate to a first threshold. For example, the means for comparing the partial frame rate to the first threshold may include the analyzer 122 of FIG. 1, the memory 176 of FIG. 1, the packet recovery rate data 106 of FIG. 1, the packet recovery rate threshold 136 of FIG. 1, the analysis data 120 of FIG. 1, the speech decoder 156 of FIG. 1, the processor 406 of FIG. 4, the processor(s) 410 of FIG. 4, the CODEC 434 of FIG. 4, vocoder decoder 438 of FIG. 4, or a combination thereof.

The apparatus may also include means for comparing the frame erasure rate to a second threshold. For example, the means for comparing the frame erasure rate to the second threshold may include the analyzer 122 of FIG. 1, the memory 176 of FIG. 1, the FER data 154 of FIG. 1, the FER threshold 138 of FIG. 1, the analysis data 120 of FIG. 1, the speech decoder 156 of FIG. 1, the processor 406 of FIG. 4, the processor(s) 410 of FIG. 4, the CODEC 434 of FIG. 4, vocoder decoder 438 of FIG. 4, or a combination thereof.

The apparatus may also include means for adjusting a delay of a buffer based on the partial frame recovery rate and based on the frame erasure rate. For example, the means for adjusting the delay of the buffer may include the analyzer 122 of FIG. 1, the memory 176 of FIG. 1, the FER data 154 of FIG. 1, the packet recovery rate threshold 136 of FIG. 1, the buffer depth data 110 of FIG. 1, the buffer 126 of FIG. 1, the analysis data 120 of FIG. 1, the speech decoder 156 of FIG. 1, the processor 406 of FIG. 4, the processor(s) 410 of FIG. 4, the CODEC 434 of FIG. 4, vocoder decoder 438 of FIG. 4, or a combination thereof.

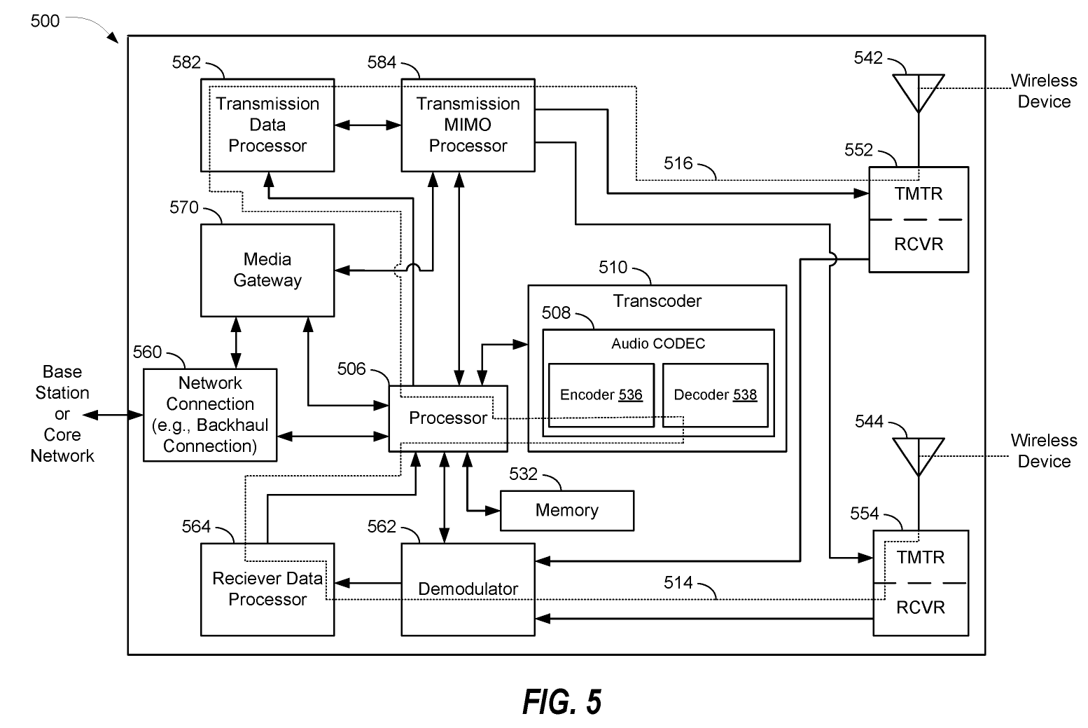

Referring to FIG. 5, a block diagram of a particular illustrative example of a base station 500 is depicted. In various implementations, the base station 500 may have more components or fewer components than illustrated in FIG. 5. In an illustrative example, the base station 500 includes the destination device 102 of FIG. 1. In an illustrative example, the base station 500 may operate according to the techniques described with reference to FIGS. 1-4.

The base station 500 may be part of a wireless communication system. The wireless communication system may include multiple base stations and multiple wireless devices. The wireless communication system may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA.

The wireless device may also be referred to as user equipment (UE), a mobile station, a terminal, an access terminal, a subscriber unit, a station, etc. The wireless device may include a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc. The wireless device may include or correspond to the device 400 of FIG. 4.

Various functions may be performed by one or more components of the base station 500 (and/or in other components not shown), such as sending and receiving messages and data (e.g., audio data). In a particular example, the base station 500 includes a processor 506 (e.g., a CPU). The base station 500 includes a transcoder 510. The transcoder 510 includes an audio CODEC 508. For example, the transcoder 510 may include one or more components (e.g., circuitry) configured to perform operations of the audio CODEC 508. As another example, the transcoder 510 is configured to execute one or more computer-readable instructions to perform the operations of the audio CODEC 508. Although the audio CODEC 508 is illustrated as a component of the transcoder 510, in other examples one or more components of the audio CODEC 508 may be included in the processor 506. For example, a decoder 538 (e.g., a vocoder decoder) may be included in a receiver data processor 564. As another example, an encoder 536 (e.g., a vocoder encoder) may be included in a transmission data processor 582. The audio CODEC 508 includes the encoder 536 and the decoder 538. The decoder 538 includes the speech decoder 156 of FIG. 1.

The transcoder 510 may function to transcode messages and data between two or more networks. The transcoder 510 may be configured to convert message and audio data from a first format (e.g., a digital format) to a second format. To illustrate, the decoder 538 may decode encoded signals having a first format and the encoder 536 may encode the decoded signals into encoded signals having a second format. Additionally or alternatively, the transcoder 510 may be configured to perform data rate adaptation. For example, the transcoder 510 may down-convert a data rate or up-convert the data rate without changing a format of the audio data. To illustrate, the transcoder 510 may down-convert 64 kbit/s signals into 16 kbit/s signals.

The base station 500 includes a memory 532, such as a computer-readable storage device, that includes instructions. The instructions may include one or more instructions that are executable by the processor 506, the transcoder 510, or a combination thereof, to perform one or more operations described with reference to the methods and systems of FIGS. 1-4. For example, the instructions may cause the processor 506 to perform operations including determining a partial frame recovery rate of lost frames at the base station 500 and adjusting the delay of a buffer based at least in part on the partial frame recovery rate. The base station 500 may include multiple transmitters and receivers (e.g., transceivers), such as a first transceiver 552 and a second transceiver 554, coupled to an array of antennas. The array of antennas includes a first antenna 542 and a second antenna 544. The array of antennas may be configured to wirelessly communicate with one or more wireless devices, such as the device 400 of FIG. 4. For example, the second antenna 544 may receive a data stream 514 (e.g., a bit stream) from a wireless device. The data stream 514 may include messages, data (e.g., encoded speech data), or a combination thereof.

The base station 500 includes a network connection 560, such as a backhaul connection. The network connection 560 may be configured to communicate with a core network or one or more base stations of the wireless communication network. For example, the base station 500 may receive a second data stream (e.g., messages or audio data) from a core network via the network connection 560. The base station 500 may process the second data stream to generate messages or audio data and provide the messages or the audio data to one or more wireless devices via one or more antennas of the array of antennas or to another base station via the network connection 560. In a particular implementation, the network connection 560 may be a wide area network (WAN) connection, as an illustrative, non-limiting example. In some implementations, the core network may include or correspond to a packet backbone network.

The base station 500 includes a media gateway 570 that is coupled to the network connection 560 and the processor 506. The media gateway 570 may be configured to convert between media streams of different telecommunications technologies. For example, the media gateway 570 may convert between different transmission protocols, different coding schemes, or both. To illustrate, the media gateway 570 may convert from PCM signals to Real-Time Transport Protocol (RTP) signals, as an illustrative, non-limiting example. The media gateway 570 may convert data between packet switched networks (e.g., a Voice Over Internet Protocol (VoIP) network, an IP Multimedia Subsystem (IMS), a fourth generation (4G) wireless network, such as LTE, WiMax, and UMB, etc.), circuit switched networks, and hybrid networks (e.g., a second generation (2G) wireless network, such as GSM, GPRS, and EDGE, a third generation (3G) wireless network, such as WCDMA, EV-DO, and HSPA, etc.).

Additionally, the media gateway 570 includes a transcoder and may be configured to transcode data when codecs are incompatible. For example, the media gateway 570 may transcode between an Adaptive Multi-Rate (AMR) codec and a G.711 codec, as an illustrative, non-limiting example. The media gateway 570 may include a router and a plurality of physical interfaces. In some implementations, the media gateway 570 may also include a controller (not shown). In a particular implementation, the media gateway controller may be external to the media gateway 570, external to the base station 500, or both. The media gateway controller may control and coordinate operations of multiple media gateways. The media gateway 570 may receive control signals from the media gateway controller and may function to bridge between different transmission technologies and may add service to end-user capabilities and connections.

The base station 500 includes a demodulator 562 that is coupled to the transceivers 552, 554, the receiver data processor 564, and the processor 506, and the receiver data processor 564 may be coupled to the processor 506. The demodulator 562 may be configured to demodulate modulated signals received from the transceivers 552, 554 and to provide demodulated data to the receiver data processor 564. The receiver data processor 564 may be configured to extract a message or audio data from the demodulated data and send the message or the audio data to the processor 506.

The base station 500 includes a transmission data processor 582 and a transmission multiple input-multiple output (MIMO) processor 584. The transmission data processor 582 may be coupled to the processor 506 and the transmission MIMO processor 584. The transmission MIMO processor 584 may be coupled to the transceivers 552, 554 and the processor 506. In some implementations, the transmission MIMO processor 584 may be coupled to the media gateway 570. The transmission data processor 582 may be configured to receive the messages or the audio data from the processor 506 and to code the messages or the audio data based on a coding scheme, such as CDMA or orthogonal frequency-division multiplexing (OFDM), as an illustrative, non-limiting examples. The transmission data processor 582 may provide the coded data to the transmission MIMO processor 584.

The coded data may be multiplexed with other data, such as pilot data, using CDMA or OFDM techniques to generate multiplexed data. The multiplexed data may then be modulated (i.e., symbol mapped) by the transmission data processor 582 based on a particular modulation scheme (e.g., Binary phase-shift keying (“BPSK”), Quadrature phase-shift keying (“QSPK”), M-ary phase-shift keying (“M-PSK”), M-ary Quadrature amplitude modulation (“M-QAM”), etc.) to generate modulation symbols. In a particular implementation, the coded data and other data may be modulated using different modulation schemes. The data rate, coding, and modulation for each data stream may be determined by instructions executed by the processor 506.

The transmission MIMO processor 584 may be configured to receive the modulation symbols from the transmission data processor 582 and may further process the modulation symbols and may perform beamforming on the data. For example, the transmission MIMO processor 584 may apply beamforming weights to the modulation symbols. The beamforming weights may correspond to one or more antennas of the array of antennas from which the modulation symbols are transmitted.

During operation, the second antenna 544 of the base station 500 may receive a data stream 514. The second transceiver 554 may receive the data stream 514 from the second antenna 544 and may provide the data stream 514 to the demodulator 562. The demodulator 562 may demodulate modulated signals of the data stream 514 and provide demodulated data to the receiver data processor 564. The receiver data processor 564 may extract audio data from the demodulated data and provide the extracted audio data to the processor 506.

The processor 506 may provide the audio data to the transcoder 510 for transcoding. The decoder 538 of the transcoder 510 may decode the audio data from a first format into decoded audio data and the encoder 536 may encode the decoded audio data into a second format. In some implementations, the encoder 536 may encode the audio data using a higher data rate (e.g., up-convert) or a lower data rate (e.g., down-convert) than received from the wireless device. In other implementations, the audio data may not be transcoded. Although transcoding (e.g., decoding and encoding) is illustrated as being performed by a transcoder 510, the transcoding operations (e.g., decoding and encoding) may be performed by multiple components of the base station 500. For example, decoding may be performed by the receiver data processor 564 and encoding may be performed by the transmission data processor 582. In other implementations, the processor 506 may provide the audio data to the media gateway 570 for conversion to another transmission protocol, coding scheme, or both. The media gateway 570 may provide the converted data to another base station or core network via the network connection 560.

The decoder 438 may determine a partial frame recovery rate of lost frames at the base station 500 (e.g., a receiving terminal). The decoder 538 may also adjust the delay of the buffer based at least in part on the partial frame recovery rate.

The transcoded audio data from the transcoder 510 may be provided to the transmission data processor 582 for coding according to a modulation scheme, such as OFDM, to generate the modulation symbols. The transmission data processor 582 may provide the modulation symbols to the transmission MIMO processor 584 for further processing and beamforming. The transmission MIMO processor 584 may apply beamforming weights to the modulation symbols and provide the resulting signals to one or more antennas of the array of antennas, such as the first antenna 542 via the first transceiver 552. Thus, the base station 500 may provide a transcoded data stream 516, that corresponds to the data stream 514 received from the wireless device, to another wireless device. The transcoded data stream 516 may have a different encoding format, data rate, or both, than the data stream 514. In other implementations, the transcoded data stream 516 may be provided to the network connection 560 for transmission to another base station or a core network.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein and is to be accorded the widest scope possible consistent with the principles and novel features as defined by the following claims.

What is claimed is:

1. A method for adjusting a delay of a buffer at a receiving terminal, the method comprising:
determining, at a processor, a partial frame recovery rate of lost frames at the receiving terminal; and
adjusting the delay of the buffer based at least in part on the partial frame recovery rate.

2. The method of claim 1, wherein the delay is further adjusted based on at least one of late arriving primary frames, late arriving partial frames, jitter associated with a wireless network, or a delay loss rate.

3. The method of claim 2, wherein the jitter is based in part on late partial copies of lost primary frames.

4. The method of claim 2, wherein the delay loss rate is based in part on late partial copies of primary lost frames.

5. The method of claim 1, wherein the delay is adapted by including partial frames that arrive before a threshold amount of time after a playout time.

6. The method of claim 5, wherein the threshold amount of time is controlled based on a packet loss rate.

7. The method of claim 1, wherein the delay of the buffer corresponds to a depth of the buffer.

8. The method of claim 1, further comprising comparing the partial frame recovery rate to a first threshold, wherein adjusting the delay of the buffer comprises increasing the delay of the buffer in response to the partial frame recovery rate failing to satisfy the first threshold.

9. The method of claim 1, further comprising determining a frame erasure rate for frames received at the receiving terminal, wherein the delay of the buffer is adjusted based on the frame erasure rate.

10. The method of claim 9, wherein the delay is adjusted based on a function of the frame erasure rate.

11. The method of claim 9, further comprising comparing the frame erasure rate to a second threshold, wherein adjusting the delay of the buffer comprises increasing the delay of the buffer in response to the frame erasure rate satisfying the second threshold.

12. The method of claim 1, further comprising:
determining a buffer underflow rate at the receiving terminal, the buffer underflow rate indicating a rate that frames arrive at the receiving terminal after corresponding playout times; and
increasing a depth of the buffer upon detecting that the buffer underflow rate satisfies a threshold.

13. The method of claim 12, further comprising, based on the buffer underflow rate, adjusting at least one of a minimum depth of the buffer or a maximum depth of the buffer.

14. The method of claim 1, further comprising increasing implicit buffer adaptation at the receiving terminal if the partial frame recovery rate fails to satisfy a threshold.

15. The method of claim 1, wherein determining the partial frame recovery rate and adjusting the delay are performed at a speech decoder of a mobile device or a base station.

16. An apparatus comprising:
a processor; and
a memory storing instructions executable by the processor to perform operations comprising:
determining a partial frame recovery rate of lost frames at the receiving terminal; and
adjusting a delay of a buffer based at least in part on the partial frame recovery rate.

17. The apparatus of claim 16, wherein the delay is further adjusted based on at least one of late arriving primary frames, late arriving partial frames, jitter associated with a wireless network, or a delay loss rate.

18. The apparatus of claim 16, wherein the processor and the memory are integrated into a speech decoder of a mobile device or a base station.

19. A non-transitory computer-readable medium comprising instructions for adjusting a delay of a buffer at a receiving terminal, the instructions, when executed by a processor, cause the processor to perform operations comprising:
determining a partial frame recovery rate of lost frames at the receiving terminal; and
adjusting the delay of the buffer based at least in part on the partial frame recovery rate.

20. The non-transitory computer-readable medium of claim 19, wherein the operations further comprise comparing the partial frame recovery rate to a first threshold, and wherein adjusting the delay of the buffer comprises increasing the delay of the buffer in response to the partial frame recovery rate failing to satisfy the first threshold.
